(19) United States
(12) Patent Application Publication
(10) Pub. No.: US 2020/0299895 A1
(43) Pub. Date: Sep. 24, 2020

(54) FIBER TREATMENT AGENT

(71) Applicant: Nippon Shokubai Co., Ltd., Osaka (JP)

(72) Inventors: Tomoya Kuroki, Osaka (JP); Mari Otani, Osaka (JP)

(21) Appl. No.: 16/088,129

(22) PCT Filed: Mar. 16, 2017
(86) PCT No.: PCT/JP2017/010608

§ 371 Date: Sep. 25, 2018

(30) Foreign Application Priority Data
Mar. 25, 2016 (JP) 2016-061321

(51) Int. Cl. D06M 15/267; D06M 15/347; D06M 15/356; C08F 228/02; C08F 220/06; C08F 220/20; C08K 5/00; C08K 5/353

(52) U.S. Cl. CPC D06M 15/267; D06M 15/347; D06M 15/3566; C08F 228/02; D06M 2101/32; C08F 220/20; C08K 5/0025; C08K 5/353; C08F 220/06

(57) ABSTRACT

Provided is a fiber treatment agent which is capable of imparting excellent moisture absorbing and releasing properties and exhibits excellent wash durability. The fiber treatment agent of the present invention includes a copolymer (A) having a structural unit (I) derived from a carboxyl group-containing monomer (a) and a structural unit (II) derived from a hydroxy group-containing monomer (b).

### TECHNICAL FIELD

The present invention relates to a fiber treatment agent.

### BACKGROUND ART

Recently, there has been an increasing demand for dry fibers using cellulose fibers, polyester fibers, or the like. A technology capable of imparting additionally excellent moisture absorbing and releasing properties to such conventional dry fibers is required.

A technology involving coating fibers with a fiber treatment agent to impart various functionalities has hitherto been known (for example, Patent Literature 1). However, the fibers imparted with various functionalities through coating as described above have poor wash durability, and have a problem in that the various functionalities are significantly reduced through washing.

### CITATION LIST

### Patent Literature

### [PTL 1] JP 2008-280652 A

### SUMMARY OF INVENTION

### Technical Problem

An object of the present invention is to provide a fiber treatment agent which is capable of imparting excellent moisture absorbing and releasing properties and exhibits excellent wash durability.

### Solution to Problem

According to one embodiment of the present invention, there is provided a fiber treatment agent, including a copolymer (A) having a structural unit (I) derived from a carboxyl group-containing monomer (a) and a structural unit (II) derived from a hydroxy group-containing monomer (b).

In one embodiment, the carboxyl group-containing monomer (a) is represented by the general formula (a-1) and the structural unit (I) is represented by the general formula (I-1):

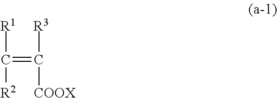

in the general formula (a-1), R¹ to R³ are identical to or different from each other, and each represent a hydrogen atom, a methyl group, or a —(CH₂)_{z}COOM group, the —(CH₂)_{z}COOM group may form an anhydride with a —COOX group or any other —(CH₂)_{z}COOM group, z represents an integer of from 0 to 2, M represents a hydrogen atom, an alkali metal, an alkaline earth metal, an ammonium group, an organic ammonium group, or an organic amine group, and X represents a hydrogen atom, an alkali metal, an alkaline earth metal, an ammonium group, an organic ammonium group, or an organic amine group;

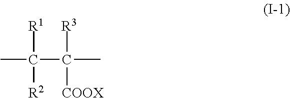

in the general formula (I-1), R¹ to R³ are identical to or different from each other, and each represent a hydrogen atom, a methyl group, or a —(CH₂)_{z}COOM group, the —(CH₂)_{z}COOM group may form an anhydride with a —COOX group or any other —(CH₂)_{z}COOM group, z represents an integer of from 0 to 2, M represents a hydrogen atom, an alkali metal, an alkaline earth metal, an ammonium group, an organic ammonium group, or an organic amine group, and X represents a hydrogen atom, an alkali metal, an alkaline earth metal, an ammonium group, an organic ammonium group, or an organic amine group.

In one embodiment, the carboxyl group-containing monomer (a) includes (meth)acrylic acid (salt).

In one embodiment, the hydroxy group-containing monomer (b) is represented by the general formula (b-1) and the structural unit (II) is represented by the general formula (II-1):

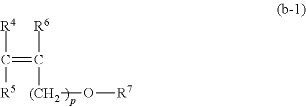

in the general formula (b-1), R⁴ to R⁶ are identical to or different from each other, and each represent a hydrogen atom or a methyl group, p represents an integer of from 0 to 2, and R⁷ represents an organic group which has a hydroxy group and may have a hetero atom;

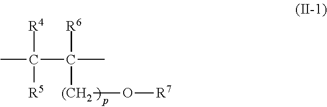

in the general formula (II-1), R⁴ to R⁶ are identical to or different from each other, and each represent a hydrogen atom or a methyl group, p represents an integer of from 0 to 2, and R⁷ represents an organic group which has a hydroxy group and may have a hetero atom.

In one embodiment, the hydroxy group-containing monomer (b) includes a sulfonic acid group-containing ether compound represented by the general formula (1):

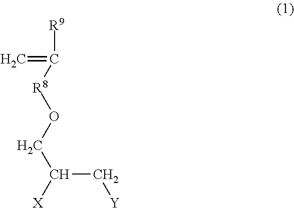

in the general formula (1), R⁸ represents any one of a single bond, CH₂, and CH₂CH₂, R⁹ represents any one of H and CH₃, and one of X and Y represents a hydroxy group, and another thereof represents a sulfonic acid (salt) group.

In one embodiment, the hydroxy group-containing monomer (b) includes an unsaturated polyalkylene glycol ether-based monomer represented by the general formula (2):

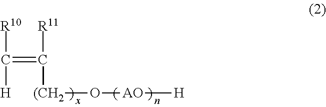

in the general formula (2), R¹⁰ and R¹¹ are identical to or different from each other, and each represent a hydrogen atom or a methyl group, AO represents an oxyalkylene group having 2 to 18 carbon atoms, n represents an average number of moles added of oxyalkylene groups each represented by AO, n represents a number of from 1 to 500, and x represents an integer of from 0 to 2.

In one embodiment, the fiber treatment agent of the present invention further includes a cross-linking agent (B) having an oxazoline group.

In one embodiment, the fiber treatment agent of the present invention is used for treatment of cellulose fibers.

In one embodiment, the fiber treatment agent of the present invention is used for treatment of polyester fibers.

According to one embodiment of the present invention, there is provided a cellulose fiber, which is treated with the fiber treatment agent of the present invention.

According to one embodiment of the present invention, there is provided a polyester fiber, which is treated with the fiber treatment agent of the present invention.

According to one embodiment of the present invention, there is provided a fiber treatment agent composition, including fibers and the fiber treatment agent of the present invention.

According to one embodiment of the present invention, there is provided a fiber treatment method, including treating fibers with the fiber treatment agent of the present invention.

In one embodiment, the fiber treatment method of the present invention includes the steps of: coating surfaces of the fibers with the fiber treatment agent; and heating the fibers to dryness.

### Advantageous Effects of Invention

According to the present invention, the fiber treatment agent, which is capable of imparting excellent moisture absorbing and releasing properties and exhibits excellent wash durability, can be provided.

### DESCRIPTION OF EMBODIMENTS

The term “mass” as used herein, which is known as an SI unit representing weight, may be replaced with the term “weight”, which has hitherto been generally commonly used as a unit of weight. Meanwhile, the term “weight” as used herein, which has hitherto been generally commonly used as a unit of weight, may be replaced with the term “mass”, which is known as an SI unit representing weight.

The term “acid (salt)” as used herein means an acid and/or an acid salt. Preferred examples of the “salt” include: alkali metal salts, such as a sodium salt and a potassium salt; alkaline earth metal salts, such as a calcium salt and a magnesium salt; ammonium salts; and organic amine salts, such as a monoethanolamine salt, a diethanolamine salt, and a triethanolamine salt. The “salt” may be only one kind, or may be a mixture of two or more kinds. The “salt” is more preferably an alkali metal salt, such as a sodium salt or a potassium salt, and is still more preferably a sodium salt.

As used herein, the term “(meth) acrylic” means “acrylic and/or methacrylic”, the term “(meth) acrylate” means “acrylate and/or methacrylate”, the term “(meth) allyl” means “allyl and/or methallyl”, and the term “(meth) acrolein” means “acrolein and/or methacrolein”.

The term “structural unit derived from a monomer” means such a structural unit that an unsaturated double bond in the monomer that is involved in a polymerization reaction is turned into a single bond by the polymerization reaction. Specifically, when the monomer is represented by “R^{a}R^{b}C═CR^{c}R^{d}”, the term means a structural unit represented by “—R^{a}R^{b}C—CR^{c}R^{d}-” in the copolymer. For example, a structural unit derived from acrylic acid is represented by “—CH₂—CH(COOH)—”, and a structural unit derived from maleic acid is represented by “—CH(COOH)—CH(COOH)—”.

### <<<<Fiber Treatment Agent>>>>

A fiber treatment agent of the present invention contains a copolymer (A) having a structural unit (I) derived from a carboxyl group-containing monomer (a) and a structural unit (II) derived from a hydroxy group-containing monomer (b). Such copolymers (A) may be used alone or in combination thereof.

The content of the copolymer (A) in the fiber treatment agent of the present invention is preferably from 50 wt % to 100 wt %, more preferably from 70 wt % to 100 wt %, still more preferably from 90 wt % to 100 wt %, particularly preferably from 95 wt % to 100 wt %, most preferably substantially 100 wt %. The term “substantially 100 wt %” refers to a case in which a component which does not affect the expression of the effects of the present invention is contained in an extremely small amount. When the content of the copolymer (A) in the fiber treatment agent of the present invention falls within the above-mentioned range, the fiber treatment agent of the present invention is capable of imparting additionally excellent moisture absorbing and releasing properties and exhibits additionally excellent wash durability.

The fiber treatment agent of the present invention may contain any appropriate other component in addition to the copolymer (A) to the extent that the effects of the present invention are not impaired. Such other components may be used alone or in combination thereof.

The fiber treatment agent of the present invention may be used as an aqueous solution. When the fiber treatment agent of the present invention is used as an aqueous solution, the content of the fiber treatment agent in the aqueous solution in terms of solid content concentration is preferably from 3 wt % to 80 wt %, more preferably from 5 wt % to 70 wt %, still more preferably from 7 wt % to 60 wt %, particularly preferably from 10 wt % to 55 wt %.

The copolymer (A) has a weight average molecular weight (Mw) of preferably from 500 to 1,500,000, more preferably from 1,000 to 1,200,000, still more preferably from 1,500 to 1,000,000, particularly preferably from 2,000 to 800,000, most preferably from 2,500 to 600,000. When the copolymer (A) has a weight average molecular weight (Mw) falling within the above-mentioned range, the fiber treatment agent of the present invention is capable of imparting additionally excellent moisture absorbing and releasing properties and exhibits additionally excellent wash durability. The details of a measurement method for the weight average molecular weight (Mw) of the copolymer (A) are described later.

The copolymer (A) may have a structural unit (III) derived from any appropriate other monomer (c) to the extent that the effects of the present invention are not impaired as long as the copolymer (A) has the structural unit (I) derived from a carboxyl group-containing monomer (a) and the structural unit (II) derived from a hydroxy group-containing monomer (b). The number of kinds of the structural unit (I) derived from a carboxyl group-containing monomer (a) may be one or two or more. The number of kinds of the structural unit (II) derived from a hydroxy group-containing monomer (b) may be one or two or more. The number of kinds of the structural unit (III) derived from the other monomer (c) may be one or two or more.

The total content of the structural unit (I) and the structural unit (II) in all the structural units of the copolymer (A) in terms of molar ratio is preferably from 10 mol % to 100 mol %, more preferably from 20 mol % to 100 mol %, still more preferably from 25 mol % to 100 mol %, particularly preferably from 30 mol % to 100 mol %, most preferably from 35 mol % to 100 mol %. When the total content of the structural unit (I) and the structural unit (II) in all the structural units of the copolymer (A) falls within the above-mentioned range, the fiber treatment agent of the present invention is capable of imparting additionally excellent moisture absorbing and releasing properties and exhibits additionally excellent wash durability.

In the copolymer (A), the content ratio between the structural unit (I) and the structural unit (II), (I):(II), in terms of molar ratio is preferably from 99:1 to 1:99, more preferably from 99:1 to 5:95, still more preferably from 99:1 to 10:90, particularly preferably from 98:2 to 15:85, most preferably from 98:2 to 20:80. When the content ratio between the structural unit (I) and the structural unit (II) falls within the above-mentioned range, the fiber treatment agent of the present invention is capable of imparting additionally excellent moisture absorbing and releasing properties and exhibits additionally excellent wash durability.

A carboxyl group of the structural unit (I) and a hydroxy group of the structural unit (II) of the copolymer (A) contained in the fiber treatment agent of the present invention may preferably cause a self-cross-linking reaction through heat treatment. In addition, the carboxyl group of the structural unit (I) of the copolymer (A) contained in the fiber treatment agent of the present invention may preferably cause a cross-linking reaction with a hydroxy group which may be present on surfaces of fibers (e.g., cellulose fibers) to be treated through the heat treatment. In addition, the hydroxy group of the structural unit (II) of the copolymer (A) contained in the fiber treatment agent of the present invention may preferably cause a cross-linking reaction with a carboxyl group which may be present on the surfaces of the fibers (e.g., polyester fibers) to be treated through the heat treatment. Through such self-cross-linking reaction and cross-linking reactions, the fiber treatment agent of the present invention is capable of imparting additionally excellent moisture absorbing and releasing properties and exhibits additionally excellent wash durability.

Any appropriate monomer having a carboxyl group and a polymerizable unsaturated double bond may be adopted as the carboxyl group-containing monomer (a) to the extent that the effects of the present invention are not impaired.

A preferred example of the carboxyl group-containing monomer (a) is a monomer represented by the general formula (a-1). In this case, a preferred example of the structural unit (I) derived from a carboxyl group-containing monomer (a) is a structural unit represented by the general formula (I-1). Such monomers each represented by the general formula (a-1) may be used alone or in combination thereof.

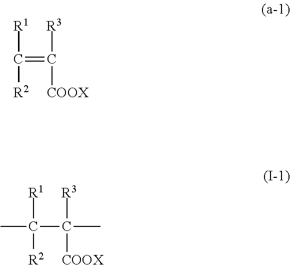

In the general formula (a-1) and the general formula (I-1), R¹ to R³ are identical to or different from each other, and each represent a hydrogen atom, a methyl group, or a —(CH₂)_{z}COOM group. The —(CH₂)_{z}COOM group may form an anhydride with a —COOX group or any other —(CH₂)_{z}COOM group. z represents an integer of from 0 to 2.

M represents a hydrogen atom, an alkali metal, an alkaline earth metal, an ammonium group, an organic ammonium group, or an organic amine group.

In the general formula (a-1) and the general formula (I-1), X represents a hydrogen atom, an alkali metal, an alkaline earth metal, an ammonium group, an organic ammonium group, or an organic amine group.

Examples of the carboxyl group-containing monomer represented by the general formula (a-1) include a monoethylenically unsaturated monocarboxylic acid (salt) serving as a monomer (a1) and a monoethylenically unsaturated dicarboxylic acid (salt) or an anhydride thereof serving as a monomer (a2).

The monoethylenically unsaturated monocarboxylic acid (salt) serving as the monomer (a1) is preferably a monoethylenically unsaturated monocarboxylic acid (salt) monomer having 3 to 8 carbon atoms. Examples of such monoethylenically unsaturated monocarboxylic acid (salt) serving as the monomer (a) include (meth)acrylic acid (salt), crotonic acid (salt), isocrotonic acid (salt), and α-hydroxyacrylic acid (salt). The monoethylenically unsaturated monocarboxylic acids (salts) each serving as the monomer (a1) may be used alone or in combination thereof. The monoethylenically unsaturated monocarboxylic acid (salt) serving as the monomer (a1) is preferably (meth)acrylic acid (salt), more preferably acrylic acid (salt).

The monoethylenically unsaturated dicarboxylic acid (salt) or the anhydride thereof serving as the monomer (a2) is preferably a monoethylenically unsaturated dicarboxylic acid (salt) having 4 to 6 carbon atoms or an anhydride thereof. Examples of such monoethylenically unsaturated dicarboxylic acid (salt) or the anhydride thereof serving as the monomer (a2) include maleic acid (salt), itaconic acid (salt), mesaconic acid (salt), fumaric acid (salt), and citraconic acid (salt). An anhydride of an acid that can have an anhydride form out of those acids is also included in the examples. The monoethylenically unsaturated dicarboxylic acids (salts) or the anhydrides thereof each serving as the monomer (a2) may be used alone or in combination thereof. The monoethylenically unsaturated dicarboxylic acid (salt) or the anhydride thereof serving as the monomer (a2) is preferably maleic acid (salt) or maleic anhydride (salt).

Examples of the “salt” in the monoethylenically unsaturated monocarboxylic acid (salt) serving as the monomer (a1) and the monoethylenically unsaturated dicarboxylic acid (salt) or the anhydride thereof serving as the monomer (a2) include an alkali metal salt, an alkaline earth metal salt, an ammonium salt, an organic ammonium salt, and an organic amine salt.

Examples of the alkali metal salt include a lithium salt, a sodium salt, and a potassium salt. Examples of the alkaline earth metal salt include a calcium salt and a magnesium salt.

Examples of the organic ammonium salt include a methyl ammonium salt, an ethyl ammonium salt, a dimethyl ammonium salt, a diethyl ammonium salt, a trimethyl ammonium salt, and a triethyl ammonium salt.

Examples of the organic amine salt include alkanolamine salts, such as an ethanolamine salt, a diethanolamine salt, a triethanolamine salt, a monoisopropanolamine salt, a diisopropanolamine salt, a triisopropanolamine salt, a hydroxyethyl diisopropanolamine salt, a dihydroxyethyl isopropanolamine salt, tetrakis(2-hydroxypropyl)ethylenediamine, and pentakis(2-hydroxypropyl)diethylenetriamine. Of those, a diethanolamine salt, a diisopropanolamine salt, a triisopropanolamine salt, a hydroxyethyl diisopropanolamine salt, a tetrakis(2-hydroxypropyl)ethylenediamine salt, and a pentakis(2-hydroxypropyl)diethylenetriamine salt are preferred, and a diethanolamine salt, a triisopropanolamine salt, and a hydroxyethyl diisopropanolamine salt are more preferred.

Any appropriate monomer may be adopted as the hydroxy group-containing monomer (b) to the extent that the effects of the present invention are not impaired as long as the monomer has a hydroxy group and a polymerizable unsaturated double bond.

A preferred example of the hydroxy group-containing monomer (b) is a monomer represented by the general formula (b-1). In this case, a preferred example of the structural unit (II) derived from a hydroxy group-containing monomer (b) is a structural unit represented by the general formula (II-1). Such monomers each represented by the general formula (b-1) may be used alone or in combination thereof.

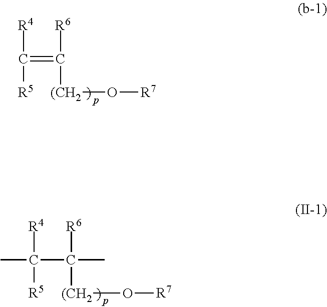

In the general formula (b-1) and the general formula (II-1), R⁴ to R⁶ are identical to or different from each other, and each represent a hydrogen atom or a methyl group.

In the general formula (b-1) and the general formula (II-1), p represents an integer of from 0 to 2.

In the general formula (b-1) and the general formula (II-1), R⁷ represents an organic group which has a hydroxy group and may have a hetero atom. More specifically, R⁷ represents an organic group having at least one hydroxy group, and the organic group may have a hetero atom, such as an oxygen atom, a sulfur atom, or a nitrogen atom.

Examples of such hydroxy group-containing monomer (b) include a sulfonic acid group-containing ether compound represented by the general formula (1), an unsaturated polyalkylene glycol ether-based monomer represented by the general formula (2), 1-allyloxy-3-butoxypropan-2-ol represented by the chemical formula (3), a hexene oxide adduct of isoprenol represented by the chemical formula (4), 2-hydroxyethyl (meth) acrylate, 2-hydroxypropyl (meth) acrylate, 3-hydroxypropyl (meth) acrylate, 2-hydroxybutyl (meth) acrylate, 4-hydroxybutyl (meth) acrylate, 3-(meth)allyloxy-1,2-dihydroxypropane, isoprenol, a polyalkylene glycol mono (meth) acrylate, a compound obtained by adding 1 mol to 200 mol of ethylene oxide with respect to 1 mol of 3-(meth)allyloxy-1,2-dihydroxypropane (e.g., 3-allyloxy-1,2-di(poly)oxyethylene ether propane), (meth)allyl alcohol, and a compound obtained by adding 1 mol to 100 mol of ethylene oxide with respect to 1 mol of (meth)allyl alcohol. When those compounds are adopted as the hydroxy group-containing monomer (b), the compounds may be used alone or in combination thereof.

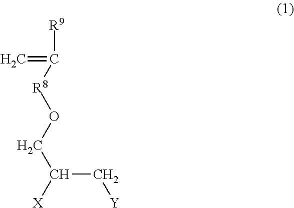

In the general formula (1), R⁸ represents any one of a single bond, CH₂, and CH₂CH₂. R⁸ preferably represents CH₂ because the effects of the present invention can be more effectively expressed.

In the general formula (1), R⁹ represents any one of H and CH₃.

In the general formula (1), one of X and Y represents a hydroxy group, and the other thereof represents a sulfonic acid (salt) group. Here, the term “sulfonic acid (salt) group” means a sulfonic acid group and/or a sulfonic acid salt group. It is preferred that X represent a hydroxy group and Y represent a sulfonic acid (salt) group because the effects of the present invention can be more effectively expressed.

The sulfonic acid group is represented by SO₃H. The sulfonic acid salt group is represented by SO₃M. M represents a metal atom, an ammonium group (constituting an ammonium salt, that is, SO₃NH₄), or an organic amino group (constituting an organic amine salt). Examples of the metal atom include: alkali metals, such as a sodium atom and a potassium atom; alkaline earth metals, such as a calcium atom; and transition metals, such as an iron atom. Examples of the organic amine salt include primary to quaternary amine salts, such as a methylamine salt, a n-butylamine salt, a monoethanolamine salt, a dimethylamine salt, a diethanolamine salt, a morpholine salt, and a trimethylamine salt. M preferably represents a sodium atom or a potassium atom out of those described above in order to sufficiently express the effects of the present invention.

Specifically, the sulfonic acid group-containing ether compound represented by the general formula (1) is preferably sodium 3-(meth) allyloxy-2-hydroxy-1-propanesulfonate, more preferably sodium 3-allyloxy-2-hydroxy-1-propanesulfonate (hereinafter sometimes referred to as “HAPS”) because the effects of the present invention can be more effectively expressed. Herein, the term “(meth) allyl” means allyl and/or methallyl.

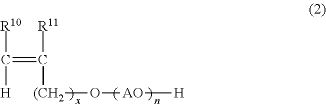

In the general formula (2), R¹⁰ and R¹¹ are identical to or different from each other, and each represent a hydrogen atom or a methyl group.

In the general formula (2), AO represents an oxyalkylene group having 2 to 18 carbon atoms, preferably an oxyalkylene group having 2 to 8 carbon atoms, more preferably an oxyalkylene group having 2 to 4 carbon atoms. In addition, when AO represents any appropriate two or more kinds selected from an oxyethylene group, an oxypropylene group, an oxybutylene group, an oxystyrene group, and the like, an addition form of these AO groups may be any form selected from random addition, block addition, alternate addition, and the like. In order to ensure a balance between hydrophilicity and hydrophobicity, it is preferred that the oxyalkylene group include an oxyethylene group as an essential component. The oxyethylene group accounts for more preferably 50 mol % or more, still more preferably 90 mol % or more, particularly preferably 100 mol % of the entirety of the oxyalkylene group.

In the general formula (2), n represents an average number of moles added (sometimes referred to as “chain length”) of oxyalkylene groups each represented by AO, and represents a number of from 1 to 500, preferably a number of from 2 to 200, more preferably a number of from 5 to 200, still more preferably a number of from 8 to 100, particularly preferably a number of from 8 to 70, most preferably a number of from 8 to 60.

In the general formula (2), x represents an integer of from 0 to 2.

Examples of the unsaturated polyalkylene glycol ether-based monomer represented by the general formula (2) include compounds each obtained by adding, on average, 1 mol to 500 mol of an alkylene oxide to any one of vinyl alcohol, (meth)allyl alcohol, 3-methyl-3-buten-1-ol, 3-methyl-2-buten-1-ol, 2-methyl-3-buten-2-ol, 2-methyl-2-buten-1-ol, and 2-methyl-3-buten-1-ol. The unsaturated polyalkylene glycol ether-based monomer represented by the general formula (2) is preferably a compound obtained by adding, on average, 1 mol to 500 mol of an alkylene oxide to 3-methyl-3-buten-1-ol or a compound obtained by adding, on average, 1 mol to 500 mol of an alkylene oxide to methallyl alcohol.

When the unsaturated polyalkylene glycol ether-based monomer represented by the general formula (2) is adopted, fibers treated with the fiber treatment agent of the present invention may be, for example, fibers improved in texture.

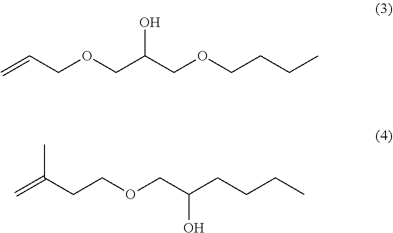

Examples of the other monomer (c) include: sulfonic acid-based monomers, for example, conjugated diene sulfonic acids, such as 2-(meth)acrylamide-2-methylpropanesulfonic acid, (meth) allylsulfonic acid, vinylsulfonic acid, styrenesulfonic acid, 2-sulfoethyl (meth) acrylate, and 2-methyl-1,3-butadiene-1-sulfonic acid, and salts thereof; N-vinyl monomers, such as N-vinylpyrrolidone, N-vinylformamide, N-vinylacetamide, N-vinyl-N-methylformamide, N-vinyl-N-methylacetamide, and N-vinyloxazolidone; amide-based monomers, such as (meth)acrylamide, N,N-dimethylacrylamide, and N-isopropylacrylamide; and (meth) acrylate-based monomers, such as methyl (meth)acrylate, ethyl (meth)acrylate, and butyl (meth) acrylate.

The copolymer (A) may be produced by polymerizing monomer components which include the carboxyl group-containing monomer (a) and the hydroxy group-containing monomer (b), and include, as required, the other monomer (c).

The total content of the carboxyl group-containing monomer (a) and the hydroxy group-containing monomer (b) in the monomer components in terms of molar ratio is preferably from 10 mol % to 100 mol %, more preferably from 20 mol % to 100 mol %, still more preferably from 25 mol % to 100 mol %, particularly preferably from 30 mol % to 100 mol %, most preferably from 35 mol % to 100 mol %. When the total content of the carboxyl group-containing monomer (a) and the hydroxy group-containing monomer (b) in the monomer components falls within the above-mentioned range, the fiber treatment agent of the present invention is capable of imparting additionally excellent moisture absorbing and releasing properties and exhibits additionally excellent wash durability.

In the monomer components, the content ratio between the carboxyl group-containing monomer (a) and the hydroxy group-containing monomer (b), (a):(b), in terms of molar ratio is preferably from 99:1 to 1:99, more preferably from 99:1 to 5:95, still more preferably from 99:1 to 10:90, particularly preferably from 98:2 to 15:85, most preferably from 98:2 to 20:80. When the content ratio between (a) and (b) falls within the above-mentioned range, the fiber treatment agent of the present invention is capable of imparting additionally excellent moisture absorbing and releasing properties and exhibits additionally excellent wash durability.

Any appropriate polymerization method may be adopted as a polymerization method that may be adopted at the time of the production of the copolymer (A). Such polymerization method is, for example, a method involving performing the polymerization in an aqueous solvent in the presence of a polymerization initiator, and in some cases, through the use of a chain transfer agent.

A solvent that may be used at the time of the production of the copolymer (A) is preferably an aqueous solvent. Examples of the aqueous solvent include water, an alcohol, a glycol, glycerin, and polyethylene glycol. Of those, water is preferred. In order that the solubility of each of the monomers in the solvent may be improved, any appropriate organic solvent may be appropriately added as required to the extent that no adverse effects are exhibited on the polymerization. Examples of such organic solvent include: lower alcohols, such as methanol, ethanol, and isopropyl alcohol; lower ketones, such as acetone, methyl ethyl ketone, and diethyl ketone; ethers, such as dimethyl ether, diethyl ether, and dioxane; and amides, such as dimethylformaldehyde. Those solvents may be used alone or in combination thereof.

The usage amount of the solvent that may be used at the time of the production of the copolymer (A) is preferably from 25 wt % to 500 wt %, more preferably from 40 wt % to 400 wt %, still more preferably from 60 wt % to 350 wt % with respect to the total amount of the monomer components. When the usage amount of the solvent is less than 25 wt % with respect to the total amount of the monomer components, the following problem may occur: the viscosity of the mixture of the components increases during the polymerization to make the mixing insufficient, and hence gel is produced. When the usage amount of the solvent is more than 500 wt % with respect to the total amount of the monomer components, a problem in that it becomes difficult to obtain a copolymer having a desired molecular weight may occur.

Most, or the total amount, of the solvent only needs to be loaded into a reaction vessel at the initial stage of the polymerization. For example, part of the solvent may be adequately added (dropped) alone into a reaction system during the polymerization. Alternatively, after the monomers, the polymerization initiator, the chain transfer agent, and any other additive have been dissolved in the solvent in advance, the solvent may be adequately added (dropped) into the reaction system during the polymerization together with the components.

Any appropriate polymerization initiator may be adopted as the polymerization initiator to the extent that the effects of the present invention are not impaired. Examples of such polymerization initiator include: hydrogen peroxide; persulfates, such as sodium persulfate, potassium persulfate, and ammonium persulfate; azo-based compounds, such as dimethyl-2,2′-azobis(2-methyl propionate), 2,2′-azobis(isobutyronitrile), 2,2′-azobis(2-methylbutyronitrile), 2,2′-azobis(2,4-dimethylvaleronitrile), 2,2′-azobis(4-methoxy-2,4-dimethylvaleronitrile), dimethyl 2,2′-azobis(isobutyrate), 4,4′-azobis(4-cyanovaleric acid), 2,2′-azobis(2-methylpropionamidine) dihydrochloride, 2,2′-azobis[N-(2-carboxyethyl)-2-methylpropionamidine] n-hydrate, 2,2′-azobis[2-(2-imidazolin-2-yl)propane] dihydrochloride, 2,2′-azobis[2-(2-imidazolin-2-yl)propane] disulfatedihydrate, and 1,1′-azobis(cyclohexane-1-carbonitrile); and organic peroxides, such as benzoyl peroxide, lauroyl peroxide, peracetic acid, di-t-butyl peroxide, and cumene hydroperoxide. Of those polymerization initiators, persulfates, such as sodium persulfate, potassium persulfate, and ammonium persulfate, are preferred because the effects of the present invention can be sufficiently expressed.

The polymerization initiators may be used alone or in combination thereof.

Any appropriate amount may be adopted as the usage amount of the polymerization initiator as long as the amount enables appropriate initiation of the copolymerization reaction. For example, such amount is preferably 15 g or less, more preferably from 0.5 g to 12 g with respect to 1 mol of the total amount of the monomers. In addition, when a maleic acid ratio is set to 20 mol % or more in the case of the production of the copolymer of the present invention, for example, the usage amount is preferably 20 g or less, more preferably from 1 g to 15 g with respect to 1 mol of the total amount of the monomers. The polymerization initiator is more preferably used in combination with an iron catalyst.

In the production of the copolymer (A), a chain transfer agent may be used as required for the purpose of, for example, adjusting the molecular weight of the copolymer (A) to be obtained to the extent that the copolymerization reaction is not adversely affected.

Any appropriate chain transfer agent may be adopted as the chain transfer agent to the extent that the effects of the present invention are not impaired. Examples of such chain transfer agent include: thiol-based chain transfer agents, such as mercaptoethanol, thioglycerol, thioglycolic acid, 2-mercaptopropionic acid, 3-mercaptopropionic acid, thiomalic acid, octyl thioglycolate, octyl 3-mercaptopropionate, 2-mercaptoethanesulfonic acid, n-dodecylmercaptan, octylmercaptan, and butyl thioglycolate; halides, such as carbon tetrachloride, methylene chloride, bromoform, and bromotrichloroethane; secondary alcohols, such as isopropanol and glycerin; and lower oxides and salts thereof, such as phosphorous acid, hypophosphorous acid, and salts thereof (e.g., sodium hypophosphite and potassium hypophosphite), and sulfurous acid, bisulfurous acid, dithionous acid, metabisulfurous acid, and salts thereof (e.g., sodium bisulfite, potassium bisulfite, ammonium bisulfite, sodium dithionite, potassium dithionite, sodium metabisulfite, and potassium metabisulfite). Of those chain transfer agents, bisulfites, such as sodium bisulfite, potassium bisulfite, and ammonium bisulfite, hypophosphorous acid, and salts thereof (e.g., sodium hypophosphite and potassium hypophosphite) are preferred because the effects of the present invention can be sufficiently expressed.

The chain transfer agents may be used alone or in combination thereof.

Any appropriate amount may be adopted as the usage amount of the chain transfer agent as long as the amount enables appropriate progress of the copolymerization reaction of the monomers. For example, such amount is preferably from 0.5 g to 20 g, more preferably from 1 g to 15 g, still more preferably from 1 g to 10 g with respect to 1 mol of the total amount of the monomers.

A continuous loading method, such as dropping or separate loading, may be applied as a method of adding the polymerization initiator and the chain transfer agent to a reaction vessel. In addition, the chain transfer agent may be introduced alone into the reaction vessel, or may be mixed in advance with, for example, the respective monomers constituting the monomer components and a solvent.

In the production of the copolymer (A), at the time of the polymerization reaction, any appropriate other additive may be used in the polymerization reaction system to the extent that the effects of the present invention are not impaired. Examples of such other additive include a reaction accelerator, a heavy metal concentration adjustor, and a pH adjustor. The reaction accelerator is used for the purpose of, for example, reducing the usage amount of the polymerization initiator or the like. The heavymetal concentration adjustor is used for the purpose of, for example, alleviating an influence on the polymerization reaction occurring when a metal is eluted in a trace amount from the reaction vessel or the like. The pH adjustor is used for the purposes of, for example, improving the efficiency of the polymerization reaction, and preventing the occurrence of a sulfurous acid gas and the corrosion of an apparatus when the bisulfite is used as the initiator system.

For example, a heavy metal compound may be utilized as the reaction accelerator. Specific examples thereof may include: water-soluble polyvalent metal salts, such as vanadium oxytrichloride, vanadium trichloride, vanadyl oxalate, vanadyl sulfate, vanadic anhydride, ammonium metavanadate, ammonium hypovanadous sulfate [(NH₄)₂SO₄.VSO₄.6H₂O], ammonium vanadous sulfate [(NH₄)V(SO₄)₂.12H₂O], copper(II) acetate, copper(II), copper(II) bromide, copper(II) acetylacetate, cupric ammonium chloride, copper ammonium chloride, copper carbonate, copper(II) chloride, copper(II) citrate, copper(II) formate, copper(II) hydroxide, copper nitrate, copper naphthenate, copper(II) oleate, copper maleate, copper phosphate, copper(II) sulfate, cuprous chloride, copper(I) cyanide, copper iodide, copper(I) oxide, copper thiocyanate, iron acetylacetonate, iron ammonium citrate, ferric ammonium oxalate, iron ammonium sulfate, Mohr's salt, ferric ammonium sulfate, iron citrate, iron fumarate, iron maleate, ferrous lactate, ferric nitrate, iron pentacarbonyl, ferric phosphate, and ferric pyrophosphate; polyvalent metal oxides, such as vanadium pentaoxide, copper(II) oxide, ferrous oxide, and ferric oxide; polyvalent metal sulfides, such as iron(III) sulfide, iron(II) sulfide, and copper sulfide; copper powder; and iron powder. The reaction accelerators may be used alone or in combination thereof.

A polyvalent metal compound or simple substance may be utilized as the heavy metal concentration adjustor. Specific examples thereof may include: water-soluble polyvalent metal salts, such as vanadium oxytrichloride, vanadium trichloride, vanadyl oxalate, vanadyl sulfate, vanadic anhydride, ammonium metavanadate, ammonium hypovanadous sulfate [(NH₄)₂SO₄.VSO₄.6H₂O], ammonium vanadous sulfate [(NH₄)V(SO₄)₂.12H₂O], copper(II) acetate, copper(II), copper(II) bromide, copper(II) acetylacetate, cupric ammonium chloride, copper ammonium chloride, copper carbonate, copper(II) chloride, copper(II) citrate, copper(II) formate, copper(II) hydroxide, copper nitrate, copper naphthenate, copper(II) oleate, copper maleate, copper phosphate, copper(II) sulfate, cuprous chloride, copper(I) cyanide, copper iodide, copper(I) oxide, copper thiocyanate, iron acetylacetonate, iron ammonium citrate, ferric ammonium oxalate, iron ammonium sulfate, Mohr's salt, ferric ammonium sulfate, iron citrate, iron fumarate, iron maleate, ferrous lactate, ferric nitrate, iron pentacarbonyl, ferric phosphate, and ferric pyrophosphate; polyvalent metal oxides, such as vanadium pentaoxide, copper(II) oxide, ferrous oxide, and ferric oxide; polyvalent metal sulfides, such as iron(III) sulfide, iron(II) sulfide, and copper sulfide; copper powder; and iron powder. The heavy metal concentration adjustors may be used alone or in combination thereof.

Examples of the pH adjustor include: hydroxides of alkali metals, such as sodium hydroxide and potassium hydroxide; hydroxides of alkaline earth metals, such as calcium hydroxide and magnesium hydroxide; and organic amine salts, such as ammonia, monoethanolamine, diethanolamine, and triethanolamine. Of those, hydroxides of alkali metals, such as sodium hydroxide and potassium hydroxide, are preferred, and sodium hydroxide is particularly preferred. The pH adjustor is sometimes referred to as “neutralizer”. The pH adjustors may be used alone or in combination thereof.

In the production of the copolymer (A), the polymerization temperature of the polymerization reaction may be set to any appropriate temperature to the extent that the effects of the present invention are not impaired. A lower limit for the polymerization temperature is preferably 50° C. or more, more preferably 60° C. or more, and an upper limit for the polymerization temperature is preferably 110° C. or less, more preferably 105° C. or less because the copolymer can be efficiently produced. In addition, the upper limit for the polymerization temperature may be set to any appropriate temperature equal to or lower than the boiling point of a polymerization reaction solution.

In the production of the copolymer (A), when a method in which the polymerization is initiated from room temperature (room temperature initiation method) is adopted, e.g., when the polymerization is performed within 240 minutes per batch (180-minute formulation), the temperature of the reaction system is caused to reach a preset temperature, which falls within the range of the polymerization temperature, and is preferably from 70° C. to 110° C., more preferably from 80° C. to 105° C., within preferably from 0 minutes to 70 minutes, more preferably from 0 minutes to 50 minutes, still more preferably from 0 minutes to 30 minutes. After that, the preset temperature is preferably maintained till the end of the polymerization.

In the production of the copolymer (A), a pressure in the reaction system may be set to any appropriate pressure to the extent that the effects of the present invention are not impaired. Examples of such pressure include normal pressure (atmospheric pressure), reduced pressure, and increased pressure.

In the production of the copolymer (A), an atmosphere in the reaction system may be set to any appropriate atmosphere to the extent that the effects of the present invention are not impaired. Examples of such atmosphere include an air atmosphere and an inert gas atmosphere.

In the production of the copolymer (A), the polymerization reaction of the monomers is preferably performed under an acidic condition. When the polymerization reaction is performed under the acidic condition, an increase in viscosity of the solution in the polymerization reaction system can be suppressed, and hence a low-molecular weight copolymer can be satisfactorily produced. Moreover, the polymerization reaction can be advanced under a higher concentration condition than a conventional one, and hence the production efficiency of the copolymer can be significantly improved. For example, when a degree of neutralization during the polymerization is adjusted to fall within the range of from 0 mol % to 50 mol %, an effect exhibited by a reduction in amount of the polymerization initiator can be synergistically increased, and hence a reducing effect on the amount of impurities can be markedly increased. Further, the pH of the reaction solution during the polymerization at 25° C. is preferably adjusted to fall within the range of from 1 to 6. When the polymerization reaction is performed under such acidic condition, the polymerization can be performed at a high concentration and in one stage. Accordingly, a concentrating step that has been required in some cases in a related-art production method can be omitted. Therefore, the productivity of the copolymer significantly improves and an increase in production cost therefor can be suppressed.

The pH of the reaction solution during the polymerization at 25° C. preferably falls within the range of from 1 to 6, more preferably falls within the range of from 1 to 5, and still more preferably falls within the range of from 1 to 4. When the pH of the reaction solution during the polymerization at 25° C. is less than 1, a sulfurous acid gas or the corrosion of the apparatus may occur in, for example, the case where the bisulfite is used as the initiator system. When the pH of the reaction solution during the polymerization at 25° C. is more than 6, in the case where the bisulfite is used as the initiator system, the efficiency with which the bisulfite is used may reduce and hence the molecular weight of the copolymer may increase.

For example, the pH adjustor only needs to be used in the adjustment of the pH of the reaction solution during the polymerization at 25° C.

The degree of neutralization during the polymerization preferably falls within the range of from 0 mol % to 50 mol %, more preferably falls within the range of from 0 mol % to 25 mol %, and still more preferably falls within the range of from 0 mol % to 20 mol %. When the degree of neutralization during the polymerization falls within such range, the monomers can be satisfactorily copolymerized and hence the amount of impurities can be reduced.

Any appropriate method may be adopted as a method for neutralization to the extent that the effects of the present invention are not impaired. For example, a (meth)acrylate, such as sodium (meth) acrylate, may be used as part of the raw materials, a hydroxide of an alkali metal, such as sodium hydroxide, may be used as the neutralizer to perform the neutralization during the polymerization, or the (meth) acrylate and the hydroxide may be used in combination. In addition, with regard to the addition form of the neutralizer at the time of the neutralization, the neutralizer may be added in the form of a solid, or may be added in the form of an aqueous solution prepared by dissolving the neutralizer in a proper solvent (preferably water).

When the polymerization reaction is performed with the neutralizer in the form of an aqueous solution, the concentration of the aqueous solution is preferably from 10 wt % to 80 wt %, more preferably from 20 wt % to 70 wt %, still more preferably from 30 wt % to 60 wt %. When the concentration of the aqueous solution is less than 10 wt %, the transportation and storage of the solution may become complicated. When the concentration of the aqueous solution is more than 80 wt %, the solution may become difficult to handle.

At the time of the polymerization, the following is preferably adopted. The monomers, the polymerization initiator, and the chain transfer agent, and as required, the other additive are dissolved in advance in a proper solvent (preferably a solvent of the same kind as that of a solvent for a liquid to be dropped) to prepare a solution of the monomers, a solution of the polymerization initiator, and a solution of the chain transfer agent, and as required, a solution of the other additive, and the polymerization is performed while each of the solutions is continuously dropped to a solvent loaded into the reaction vessel (regulated to a predetermined temperature as required) over a predetermined dropping time. Further, part of the solvent may be dropped later separately from the initially loaded solvent that has been loaded in advance into the vessel in the reaction system. With regard to a dropping method, each solution may be continuously dropped, or may be intermittently dropped in several portions. In addition, part or the whole amount of one or two or more kinds of the monomers may be initially loaded. In addition, the rate at which one or two or more kinds of the monomers are dropped may be always constant during a time period from the initiation of the dropping to its end, or the dropping rate may be changed with time in accordance with, for example, the polymerization temperature. In addition, there is no need to drop all dropping components in the same manner, and the time point when the dropping is initiated or the time point when the dropping is ended may be shifted from dropping component to dropping component, or a dropping time may be shortened or lengthened from dropping component to dropping component. In addition, when the respective components are dropped in solution forms, each of the dropping solutions may be warmed to a temperature comparable to the polymerization temperature in the reaction system. With such procedure, when the polymerization temperature is kept constant, a temperature fluctuation is reduced and hence temperature control becomes easy.

When the bisulfite is used as the initiator system, the bisulfite causes the weight average molecular weight of the copolymer at the initial stage of the polymerization to affect the final weight average molecular weight. Accordingly, in order to reduce the weight average molecular weight of the copolymer at the initial stage of the polymerization, the bisulfite or a solution thereof is added (dropped) at from 5 wt % to 35 wt % preferably within 60 minutes, more preferably within 30 minutes, still more preferably within 10 minutes from the time point when the polymerization is initiated.

When the bisulfite is used as the initiator system, the time point when the dropping of the bisulfite or the solution thereof is ended is made earlier than the time point when the dropping of the monomers is ended by preferably from 1 minute to 30 minutes, more preferably from 1 minute to 20 minutes, still more preferably from 1 minute to 15 minutes. Thus, the amount of the bisulfite remaining after the end of the polymerization can be reduced, and hence the occurrence of a sulfurous acid gas and the formation of impurities due to such remaining bisulfite can be significantly and effectively suppressed.

When the persulfate is used as the initiator system, the time point when the dropping of the persulfate or a solution thereof is ended is delayed from the time point when the dropping of the monomers is ended by preferably from 1 minute to 60 minutes, more preferably from 1 minute to 45 minutes, still more preferably from 1 minute to 20 minutes. Thus, the amount of a monomer remaining after the end of the polymerization can be reduced and hence the amount of impurities resulting from such remaining monomer can be reduced.

A solid content concentration in the polymerization solution at the time point when the polymerization reaction is ended is preferably 20 wt % or more, more preferably from 25 wt % to 70 wt %, still more preferably from 30 wt % to 60 wt %. When the solid content concentration in the polymerization solution at the time point when the polymerization reaction is ended is 20 wt % or more, the polymerization can be performed at a high concentration and in one stage. Accordingly, the copolymer (A) can be efficiently obtained. For example, the concentrating step can be omitted, and hence the production efficiency can be improved. As a result, the productivity of the copolymer (A) improves and an increase in production cost therefor can be suppressed. Herein, the time point when the polymerization reaction is ended, which may be the time point when the dropping of all dropping components is ended, preferably means the time point when a predetermined aging time elapses after the dropping (time point when the polymerization is completed).

In the production of the copolymer (A), an aging step of aging the polymerization reaction solution may be provided in order to effectively complete the polymerization after the end of the polymerization reaction. An aging time in the aging step is preferably from 1 minute to 120 minutes, more preferably from 5 minutes to 90 minutes, still more preferably from 10 minutes to 60 minutes in order to effectively complete the polymerization. The polymerization temperature is preferably applied to a temperature in the aging step. When the aging step is present in the production of the copolymer (A), the polymerization time means the sum of the total dropping time and the aging time.

An example of the other component which may be contained in the fiber treatment agent of the present invention is a cross-linking agent (B) having an oxazoline group.

When the fiber treatment agent of the present invention contains the copolymer (A) and the cross-linking agent (B) having an oxazoline group, the carboxyl group of the copolymer (A) and the oxazoline group of the cross-linking agent (B) can form a cross-linking structure. Thus, the self-cross-linking reaction of the fiber treatment agent of the present invention can sufficiently proceed in a short period of time.

Any appropriate cross-linking agent having an oxazoline group may be adopted as the cross-linking agent (B) having an oxazoline group. Such cross-linking agent (B) has an oxazoline group amount (number of oxazoline groups per 1 g of the cross-linking agent) of preferably from 0.1 mmol/g to 10 mmol/g, more preferably from 0.5 mmol/g to 8 mmol/g.

The cross-linking agent (B) having an oxazoline group is preferably a polymer having an oxazoline group (hereinafter also referred to as “oxazoline group-containing polymer”).

The oxazoline group-containing polymer preferably has a structural unit derived from an oxazoline group-containing monomer. The oxazoline group-containing polymer more preferably has the structural unit derived from an oxazoline group-containing monomer and a structural unit derived from any other monomer other than the oxazoline group-containing monomer.

Any appropriate monomer having an ethylenically unsaturated hydrocarbon group and an oxazoline group may be adopted as the oxazoline group-containing monomer. Examples of such oxazoline group-containing monomer include 2-vinyl-2-oxazoline, 5-methyl-2-vinyl-2-oxazoline, 4,4-dimethyl-2-vinyl-2-oxazoline, 4,4-dimethyl-2-vinyl-5,5-dihydro-4H-1,3-oxazoline, 2-isopropenyl-2-oxazoline, and 4,4-dimethyl-2-isopropenyl-2-oxazoline. Of those, 2-isopropenyl-2-oxazoline and 4,4-dimethyl-2-isopropenyl-2-oxazoline are preferred.

Any appropriate monomer not having an oxazoline group may be adopted as the other monomer. Examples of such other monomer include: N-vinyllactam-based monomers, such as N-vinylpyrrolidone; (meth) acrylates, such as methyl (meth)acrylate, ethyl (meth)acrylate, propyl (meth)acrylate, butyl (meth)acrylate, cyclohexyl (meth) acrylate, 2-ethylhexyl (meth) acrylate, n-octyl (meth)acrylate, iso-nonyl (meth)acrylate, dodecyl (meth)acrylate, and stearyl (meth)acrylate; N-substituted or unsubstituted (meth)acrylamides, such as (meth)acrylamide, N-monomethyl(meth)acrylamide, N-monoethyl(meth)acrylamide, and N,N-dimethyl(meth)acrylamide; vinyl aryl monomers, such as styrene, α-methylstyrene, vinyltoluene, indene, vinylnaphthalene, phenylmaleimide, and vinylaniline; alkenes, such as ethylene, propylene, butadiene, isobutylene, and octene; vinyl carboxylates, such as vinyl acetate and vinyl propionate; vinyl ethers, such as methyl vinyl ether, ethyl vinyl ether, and butyl vinyl ether; vinyl ethylene carbonate and derivatives thereof; unsaturated amines, such as N,N-dimethylaminoethyl (meth)acrylate, N,N-dimethylaminoethyl(meth)acrylamide, vinylpyridine, vinylimidazole and salts thereof or quaternary products thereof; and vinyl cyanide-based monomers, such as acrylonitrile and methacrylonitrile. Of those, a (meth)acrylate, a vinyl aryl monomer, and a vinyl cyanide-based monomer are preferred, and a (meth) acrylate is more preferred.

The (meth)acrylate is preferably an aliphatic alkyl (meth)acrylate, more preferably methyl (meth)acrylate.

The vinyl aryl monomer is preferably styrene or α-methylstyrene, more preferably styrene.

The vinyl cyanide-based monomer is preferably acrylonitrile or methacrylonitrile, more preferably acrylonitrile.

In the oxazoline group-containing polymer, the ratio of the structural unit derived from an oxazoline group-containing monomer with respect to 100 mol % of all the structural units is preferably from 20 mol % to 95 mol %, more preferably from 30 mol % to 90 mol %, still more preferably from 40 mol % to 85 mol %.

The oxazoline group-containing polymer has a weight average molecular weight of preferably from 10,000 to 150,000, more preferably from 30,000 to 130,000. The details of a measurement method for the weight average molecular weight (Mw) of the oxazoline group-containing polymer are described later.

As the oxazoline group-containing polymer, a polymer produced from a monomer component or a commercially available polymer may be used.

Fibers serving as a target for which the fiber treatment agent of the present invention may be used are preferably organic fibers or fibers for clothing because the effects of the present invention can be more effectively expressed. That is, the fibers serving as a target for which the fiber treatment agent of the present invention may be used do not preferably include inorganic fibers, such as glass fibers, and mineral fibers. Examples of the organic fibers or the fibers for clothing include: cellulose fibers, such as natural cellulose fibers, regenerated cellulose fibers, and cupra; and synthetic fibers, such as polyester fibers, nylon fibers, and polypropylene fibers.

The fibers treated with the fiber treatment agent of the present invention may be, for example, fibers having moisture absorbing and releasing properties, fibers having wash durability, or fibers improved in texture.

The fiber treatment agent of the present invention is preferably used for treatment of cellulose fibers or polyester fibers. Examples of the cellulose fibers include natural cellulose fibers, regenerated cellulose fibers, and cupra. The cellulose fibers may each have a hydroxy group on a surface thereof, and hence the carboxyl group of the structural unit (I) of the copolymer (A) contained in the fiber treatment agent of the present invention may cause a cross-linking reaction with the hydroxy group. The polyester fibers may each have a carboxyl group on a surface thereof, and hence the hydroxy group of the structural unit (II) of the copolymer (A) contained in the fiber treatment agent of the present invention may cause a cross-linking reaction with the carboxyl group. With this, the fiber treatment agent of the present invention may cause cross-linkage with the fibers as described above, in addition to self-cross-linkage between the carboxyl group of the structural unit (I) and the hydroxy group of the structural unit (II) of the copolymer (A) contained therein. Thus, the fiber treatment agent of the present invention is capable of imparting additionally excellent moisture absorbing and releasing properties and exhibits additionally excellent wash durability. The cellulose fibers thus produced treated with the fiber treatment agent of the present invention are cellulose fibers of the present invention. The polyester fibers thus produced treated with the fiber treatment agent of the present invention are polyester fibers of the present invention.

### <<<<Fiber Treatment Agent Composition>>>>

A fiber treatment agent composition of the present invention includes fibers and the fiber treatment agent of the present invention.

The fibers are preferably organic fibers or fibers for clothing as described above.

As the ratio of the fiber treatment agent to the fibers in the fiber treatment agent composition of the present invention, any appropriate ratio may be adopted depending on the kinds of the fibers and the fiber treatment agent to be used, and an intended treatment degree.

### <<<<Fiber Treatment Method>>>>

Various fibers may be subjected to fiber treatment with the fiber treatment agent of the present invention by any appropriate method. That is, a fiber treatment method of the present invention includes treating fibers with the fiber treatment agent of the present invention.

The fiber treatment method of the present invention using the fiber treatment agent of the present invention includes, for example, drying fiber cloth (pre-drying step), and then dipping the dried fiber cloth into an aqueous solution of the fiber treatment agent (dipping step), followed by dewatering (dewatering step) and as required drying (intermediate drying step), and fixing the fiber treatment agent, into which the fiber cloth has been dipped, to the fiber cloth through heating to dryness (fixation step).

Through the dipping step, the dewatering step, and the intermediate drying step to be performed as required, the surfaces of the fibers are preferably coated with the fiber treatment agent. That is, the fiber treatment method of the present invention includes the steps of: coating the surfaces of the fibers with the fiber treatment agent; and heating the fibers to dryness.

In the pre-drying step, the fiber cloth is dried at a temperature of preferably from 80° C. to 150° C. for preferably from 60 minutes to 180 minutes.

In the dipping step, the aqueous solution of the fiber treatment agent has a concentration of preferably from 1 wt % to 15 wt %, and a dipping time period for the fiber cloth is preferably from 1 minute to 30 minutes.

In the dewatering step, the dewatering is performed with, for example, a dewatering device or a mangle.

In the intermediate drying step, the fiber cloth is dried at a temperature of preferably from 80° C. to 150° C. for preferably from 1 minute to 180 minutes.

In the fixation step, for example, when the fiber cloth is cellulose fiber cloth, the fiber cloth is heated to dryness at a temperature of preferably from 100° C. to 160° C. for preferably from 1 minute to 120 minutes, and when the fiber cloth is polyester fiber cloth, the fiber cloth is heated to dryness at a temperature of preferably from 100° C. to 200° C. for preferably from 1 minute to 120 minutes.

### EXAMPLES

Now, the present invention is specifically described by way of Examples. However, the present invention is by no means limited to these Examples. The terms “part(s)” and “%” in Examples are by weight unless otherwise stated.

### <Measurement Method for Weight Average Molecular Weight (Mw) of Polymer>

(1) Measurement was performed by gel permeation chromatography (GPC). In the measurement, GF-7M HQ (manufactured by Showa Denko K.K.) was used as a column. An aqueous solution obtained by adding pure water to 34.5 g of disodium hydrogen phosphate dodecahydrate and 46.2 g of sodium dihydrogen phosphate dihydrate (JIS Special Grade reagents, all the reagents to be used in the following measurements were JIS Special Grade reagents) to adjust the total amount to 5,000 g, followed by filtration with a 0.45-micron membrane filter, was used as a mobile phase.

(2) L-7110 (manufactured by Hitachi, Ltd.) was used as a pump, the flow rate of the mobile phase was set to 0.5 ml/min, and UV (L-2400, manufactured by Hitachi, Ltd.) was used as a detector at a wavelength of 214 nm. In this case, a column temperature was set constant at 35° C.

(3) Further, a calibration curve was obtained by using a sodium polyacrylate standard sample (manufactured by Sowa Science Corporation).

(4) A sample was diluted with a solvent of the mobile phase to prepare a 0.1 wt % sample solution.

(5) SIC-48011 (manufactured by Showa Denko K.K.) was used as analysis software. With those, the weight average molecular weight of a polymer was measured.

### <Measurement Method for Solid Content of Polymer Aqueous Solution>

Gram of a polymer solution after completion of a polymerization reaction was diluted with 1 g of deionized water, followed by drying at 120° C. for 2 hours. The weight of the resultant evaporation residue was measured, and a solid content was determined by the following equation (1).

Solid content (%)=[weight of evaporation residue after drying (g)/weight of polymer solution before drying (g)]×100 (Equation 1)

<Fiber Treatment of Regenerated Cellulose Cloth with Fiber Treatment Agent>

Regenerated cellulose test cloth of 10 cm square was prepared, and pre-dried at 105° C. for 120 minutes. Then, a weight (X) of the test cloth was measured. A fiber treatment agent was dissolved in water at a concentration of 10 wt %. The test cloth was immersed in the solution, subjected to dewatering so that the amount of the aqueous solution of the fiber treatment agent remaining in the test cloth was 100±10% with respect to the cloth, and dried at 130° C. for 60 minutes (in each of Examples 1, 3, 5, 9, 10, and 12) or at 130° C. for 15 minutes (in each of Examples 14 and 16). Then, a weight (Y) of the test cloth was measured.

The ratio of the fiber treatment agent fixed to the test cloth was calculated by the following equation.

Fixed amount (%)=[(Y/X)−1]×100

<Fiber Treatment of Polyester Cloth with Fiber Treatment Agent>

Fiber treatment of polyester cloth with a fiber treatment agent was performed by the same method as that for the above-mentioned fiber treatment of regenerated cellulose cloth with a fiber treatment agent except that, in the fiber treatment of regenerated cellulose cloth with a fiber treatment agent, after the dewatering, polyester cloth was dried at 130° C. for 60 minutes and then further dried at 190° C. for 30 minutes (in each of Examples 2, 4, 6 to 8, 11, and 13) or dried at 130° C. for 5 minutes and then further dried at 190° C. for 1 minute (in each of Examples 15 and 17). A fixed amount was calculated.

### <Evaluation of Wash Durability>

The test cloth to which the fiber treatment agent had been fixed was washed once, and then dried at 130° C. for 60 minutes. A weight (Y′) of the test cloth was measured.

The ratio of the fiber treatment agent fixed to the test cloth after washing was calculated by the following equation.

Fixed amount (%)=[(Y′/X)−1]×100

### <Evaluation of Moisture Absorbing Property>

The test cloth after the evaluation of wash durability (in each of Comparative Examples, test cloth not subjected to the fiber treatment) was dried at 105° C. for 2 hours, and a weight (M) of the test cloth was measured. Subsequently, the test cloth was put into a weighing bottle, stored in a constant-temperature bath at 30° C. and a relative humidity of 90%, and taken out therefrom after 24 hours. A weight (N) of the test cloth after moisture absorption was measured. A moisture absorption rate was calculated by the following equation.

Moisture absorption rate (%)=[(N−M)/M]×100

### Example 1

6,024 Grams of a 40 wt % aqueous solution of sodium 3-allyloxy-2-hydroxy-1-propanesulfonate (hereinafter abbreviated as “40% HAPS”) was loaded into a reaction vessel made of SUS including a reflux condenser and a stirring machine, and having a volume of 25 L, and was increased in temperature under stirring so that a boiling point reflux state was achieved. Next, under stirring, 5,670 g of an 80 wt % aqueous solution of acrylic acid (hereinafter abbreviated as “80% AA”), 6,024 g of 40% HAPS, and 2,128 g of a wt % aqueous solution of sodium persulfate (hereinafter abbreviated as “15% NaPS”) (corresponding to 3.8 g with respect to 1 mol of the monomers in monomer components) were dropped into a polymerization reaction system in the boiling point reflux state. When a time point at which the addition of the 80% AA was started was used a reference (0 minutes), the 80% AA and the 40% HAPS were dropped at constant rates from 0 minutes to 90 minutes and from 0 minutes to 60 minutes, respectively. The 15% NaPS serving as an initiator was dropped at an addition rate of 9.7 g/min, and at 55 minutes, its addition rate was tripled to 29.1 g/min. The 15% NaPS was dropped from 0 minutes to 110 minutes. Next, 4, 940 g of deionized water (dilution water) was dropped at a constant rate from 50 minutes to 90 minutes. The components were dropped from nozzles different from each other, and a reaction liquid was kept in the boiling point reflux state under stirring.

After the completion of the dropping of the 15% NaPS, the reaction liquid was further kept in the boiling point reflux state for 30 minutes (aging), and polymerization was completed. Thus, an aqueous solution of a fiber treatment agent (1) serving as a polymer A was obtained. The aqueous solution of the polymer A had a solid content concentration of 40 wt %, and had a content of a residual monomer (residual HAPS) of 0.9 wt % with respect to 100 wt % of a solid content. In addition, the polymer A had a weight average molecular weight of 95,000.

Regenerated cellulose cloth was subjected to fiber treatment with the fiber treatment agent (1), and evaluated for the wash durability and the moisture absorbing property.

The results are shown in Table 1.

### Example 2

Polyester cloth was subjected to fiber treatment with the fiber treatment agent (1) obtained in Example 1, and evaluated for the wash durability and the moisture absorbing property.

The results are shown in Table 1.

### Example 3

350.8 Grams of deionized water was loaded into a reaction vessel made of SUS including a reflux condenser and a stirring machine, and having a volume of 2.5 L, and was increased in temperature under stirring so that a boiling point reflux state was achieved. Next, under stirring, 630.0 g of 80% AA, 545.0 g of 40% HAPS, 260.0 g of 100% 2-hydroxyethyl methacrylate (hereinafter abbreviated as “100% HEMA”), 267.0 g of a 15 wt % aqueous solution of sodium persulfate (hereinafter abbreviated as “15% NaPS”) (corresponding to 4.0 g with respect to 1 mol of the monomers in monomer components), and 133.3 g of 45% sodium hypophosphite monohydrate (hereinafter abbreviated as “45% SHP”) were dropped into a polymerization reaction system in the boiling point reflux state. When a time point at which the addition of the 80% AA was started was used a reference (0 minutes), the 80% AA was dropped at a constant rate from 0 minutes to 180 minutes. The 40% HAPS was dropped at an addition rate of 6.06 g/min from 0 minutes to 30 minutes and at an addition rate of 3.30 g/min from 30 minutes to 140 minutes. The 15% NaPS serving as an initiator was dropped at an addition rate of 0.97 g/min from 0 minutes to 130 minutes and at an addition rate of 2.00 g/min from 130 minutes to 200 minutes. The 45% SHP serving as a chain transfer agent was dropped at a constant rate from 0 minutes to 180 minutes. The components were dropped from nozzles different from each other, and a reaction liquid was kept in the boiling point reflux state under stirring.

After the completion of the dropping of the 15% NaPS, the reaction liquid was further kept in the boiling point reflux state for 80 minutes (aging), and polymerization was completed. Thus, an aqueous solution of a fiber treatment agent (2) serving as a polymer B was obtained. The aqueous solution of the polymer B had a solid content concentration of 50.0 wt %, and had a content of a residual monomer (residual HAPS) of 0.3 wt % with respect to 100 wt % of a solid content. In addition, the polymer B had a weight average molecular weight of 4,800.

Regenerated cellulose cloth was subjected to fiber treatment with the fiber treatment agent (2), and evaluated for the wash durability and the moisture absorbing property.

The results are shown in Table 1.

### Example 4

Polyester cloth was subjected to fiber treatment with the fiber treatment agent (2) obtained in Example 3, and evaluated for the wash durability and the moisture absorbing property.

The results are shown in Table 1.

### Example 5

190.8 Grams of deionized water and 0.02 g of Mohr's salt were loaded into a reaction vessel made of SUS including a reflux condenser and a stirring machine, and having a volume of 1 L, and were increased in temperatures up to 87° C. under stirring. Next, under stirring, 276.9 g of 80% AA, 191.7 g of 40% HAPS, 16.5 g of 81% 1-allyloxy-3-butoxypropan-2-ol (hereinafter abbreviated as “81% A1B”), 75.4 g of 15% NaPS (corresponding to 3.3 g with respect to 1 mol of the monomers in monomer components), and 43.3 g of 32.5% sodium bisulfite (hereinafter abbreviated as “32.5% SBS”) were dropped into a polymerization reaction system at 87° C. When a time point at which the addition of the 80% AA was started was used a reference (0 minutes), the 80% AA was dropped at a constant rate from 0 minutes to 180 minutes. The 40% HAPS was dropped at an addition rate of 2.6 g/min from 0 minutes to 25 minutes and at an addition rate of 1.2 g/min from 25 minutes to 130 minutes. The 81% A1B was dropped at a constant rate from 0 minutes to 130 minutes. The 15% NaPS serving as an initiator was dropped at an addition rate of 0.30 g/min from 0 minutes to 130 minutes and at an addition rate of 0.52 g/min from 130 minutes to 200 minutes. The 32.5% SBS serving as a reducing agent was dropped at a constant rate from 0 minutes to 170 minutes. The components were dropped from nozzles different from each other, and a reaction liquid was kept at 87° C. under stirring.

At 185 minutes from the start of the dropping of the 80% AA, 2.5 g of 35% hydrogen peroxide water was loaded.

After the completion of the dropping of the 15% NaPS, the reaction liquid was further kept at 87° C. for 30 minutes (aging), and polymerization was completed. Thus, an aqueous solution of a fiber treatment agent (3) serving as a polymer C was obtained. The aqueous solution of the polymer C had a solid content concentration of 45.6 wt %, and had a content of a residual monomer (residual HAPS) of 0.39 wt % with respect to 100 wt % of a solid content. In addition, the polymer C had a weight average molecular weight of 11,000.

Regenerated cellulose cloth was subjected to fiber treatment with the fiber treatment agent (3), and evaluated for the wash durability and the moisture absorbing property.

The results are shown in Table 1.

### Example 6

Polyester cloth was subjected to fiber treatment with the fiber treatment agent (3) obtained in Example 5, and evaluated for the wash durability and the moisture absorbing property.

The results are shown in Table 1.

### Example 7

503.5 Grams of deionized water and 0.03 g of Mohr's salt were loaded into a reaction vessel made of SUS including a reflux condenser and a stirring machine, and having a volume of 2.5 L, and were increased in temperatures up to 87° C. under stirring. Next, under stirring, 292.4 g of 80% AA, 295.1 g of 40% HAPS, 285.2 g of a 10 mol ethylene oxide adduct of isoprenol (hereinafter abbreviated as “IPN10”), 202.2 g of 15% NaPS (corresponding to 7.0 g with respect to 1 mol of the monomers in monomer components), and 16.0 g of 32.5% SBS were dropped into a polymerization reaction system at 87° C. When a time point at which the addition of the 80% AA was started was used a reference (0 minutes), the 80% AA and the 40% HAPS were dropped at constant rates from 0 minutes to 180 minutes and from 0 minutes to 40 minutes, respectively. The IPN10 was dropped at a constant rate from 0 minutes to 170 minutes. The 15% NaPS serving as an initiator was dropped at an addition rate of 0.73 g/min from 0 minutes to 130 minutes and at an addition rate of 1.53 g/min from 130 minutes to 200 minutes. The 32.5% SBS serving as a reducing agent was dropped at a constant rate from 0 minutes to 170 minutes. The components were dropped from nozzles different from each other, and a reaction liquid was kept at 87° C. under stirring.

After the completion of the dropping of the 15% NaPS, the reaction liquid was further kept at 87° C. for 30 minutes (aging), and polymerization was completed. Thus, an aqueous solution of a fiber treatment agent (4) serving as a polymer D was obtained. The aqueous solution of the polymer D had a solid content concentration of 50.1 wt %, and had a content of a residual monomer (residual HAPS) of 1.1 wt % with respect to 100 wt % of a solid content. In addition, the polymer D had a weight average molecular weight of 11,700.

Polyester cloth was subjected to fiber treatment with the fiber treatment agent (4), and evaluated for the wash durability and the moisture absorbing property.

The results are shown in Table 1.

### Example 8

172.9 Grams of 40% HAPS was loaded into a reaction vessel made of SUS including a reflux condenser and a stirring machine, and having a volume of 2.5 L, and was increased in temperature under stirring so that a boiling point reflux state was achieved. Next, under stirring, 247.5 g of 80% AA, 83.0 g of melted maleic acid anhydride (hereinafter abbreviated as “MA anhydride”), 172.9 g of 40% HAPS, 90.3 g of 15% NaPS (corresponding to 3.2 g with respect to 1 mol of the monomers in monomer components), and 833.3 g of deionized water were dropped into a polymerization reaction system in the boiling point reflux state. Maleic acid anhydride was melted with a dropping funnel with a jacket retained at from 60° C. to 70° C. with hot water. When a time point at which the addition of the 80% AA was started was used a reference (0 minutes), the 80% AA was dropped at a constant rate from 0 minutes to 90 minutes, and the MA anhydride and the 40% HAPS were dropped at constant rates from 0 minutes to 60 minutes. The 15% NaPS serving as an initiator was dropped at an addition rate of 0.41 g/min from 0 minutes to 55 minutes and at an addition rate of 1.23 g/min from 55 minutes to 110 minutes. The deionized water was dropped at a constant rate from 50 minutes to 90 minutes. The components were dropped from nozzles different from each other, and a reaction liquid was kept in the boiling point reflux state under stirring.

After the completion of the dropping of the 15% NaPS, the reaction liquid was further kept in the boiling point reflux state for 30 minutes (aging), and polymerization was completed. Thus, an aqueous solution of a fiber treatment agent (5) serving as a polymer E was obtained. The aqueous solution of the polymer E had a solid content concentration of 29.7 wt %, and had a content of a residual monomer (residual HAPS) of 0.10 wt % with respect to 100 wt % of a solid content. In addition, the polymer E had a weight average molecular weight of 77,200.

Polyester cloth was subjected to fiber treatment with the fiber treatment agent (5), and evaluated for the wash durability and the moisture absorbing property.

The results are shown in Table 1.

### Example 9

308.2 Grams of deionized water was loaded into a reaction vessel made of SUS including a reflux condenser and a stirring machine, and having a volume of 2.5 L, and was increased in temperature up to 87° C. under stirring. Next, under stirring, 180.5 g of 80% AA, 270.7 g of an 80 wt % aqueous solution of IPN10 (80 wt % aqueous solution of a 10 mol ethylene oxide adduct of isoprenol), 48.3 g of 15% NaPS (corresponding to 3.0 g with respect to 1 mol of the monomers in monomer components), and 29.0 g of 15% SHP were dropped into a polymerization reaction system at 87° C. When a time point at which the addition of the 80% AA was started was used a reference (0 minutes), the 80% AA, the 80 wt % aqueous solution of IPN10, and the 15% NaPS serving as an initiator were dropped at constant rates from 0 minutes to 120 minutes, from 0 minutes to 110 minutes, and from 0 minutes to 130 minutes, respectively. The 15% SHP serving as a chain transfer agent was dropped at an addition rate of 0.54 g/min from 0 minutes to 18 minutes and at an addition rate of 0.21 g/min from 18 minutes to 110 minutes. The components were dropped from nozzles different from each other, and a reaction liquid was kept at 87° C. under stirring.

After the completion of the dropping of the 15% NaPS, the reaction liquid was further kept at 87° C. for 30 minutes (aging), and polymerization was completed. After that, 13.4 g of a 48 wt % aqueous solution of sodium hydroxide (hereinafter abbreviated as “48% NaOH”) was added thereto. Thus, an aqueous solution of a fiber treatment agent (6) serving as a polymer F was obtained. The aqueous solution of the polymer F had a solid content concentration of 44.6 wt %. In addition, the polymer F had a weight average molecular weight of 53,000.

Regenerated cellulose cloth was subjected to fiber treatment with the fiber treatment agent (6), and evaluated for the wash durability and the moisture absorbing property.

The results are shown in Table 1.

### Example 10

326.6 Grams of deionized water was loaded into a reaction vessel made of SUS including a reflux condenser and a stirring machine, and having a volume of 2.5 L, and was increased in temperature up to 87° C. under stirring. Next, under stirring, 302.7 g of 80% AA, 129.7 g of an 80 wt % aqueous solution of IPN10 (80 wt % aqueous solution of a 10 mol ethylene oxide adduct of isoprenol), 71.2 g of 15% NaPS (corresponding to 3.0 g with respect to 1 mol of the monomers in monomer components), and 19.7 g of 45% SHP were dropped into a polymerization reaction system at 87° C. When a time point at which the addition of the 80% AA was started was used a reference (0 minutes), the 80% AA, the 80 wt % aqueous solution of IPN10, and the 15% NaPS serving as an initiator were dropped at constant rates from 0 minutes to 120 minutes, from 0 minutes to 110 minutes, and from 0 minutes to 130 minutes, respectively. The 45% SHP serving as a chain transfer agent was dropped at an addition rate of 0.36 g/min from 0 minutes to 18 minutes and at an addition rate of 0.14 g/min from 18 minutes to 110 minutes. The components were dropped from nozzles different from each other, and a reaction liquid was kept at 87° C. under stirring.

After the completion of the dropping of the 15% NaPS, the reaction liquid was further kept at 87° C. for 30 minutes (aging), and polymerization was completed. Thus, an aqueous solution of a fiber treatment agent (7) serving as a polymer G was obtained. The aqueous solution of the polymer G had a solid content concentration of 42.8 wt %. In addition, the polymer G had a weight average molecular weight of 26,000.

Regenerated cellulose cloth was subjected to fiber treatment with the fiber treatment agent (7), and evaluated for the wash durability and the moisture absorbing property.

The results are shown in Table 1.

### Example 11

Polyester cloth was subjected to fiber treatment with the fiber treatment agent (7) obtained in Example 10, and evaluated for the wash durability and the moisture absorbing property.

The results are shown in Table 1.

### Example 12

248.9 Grams of deionized water was loaded into a reaction vessel made of SUS including a reflux condenser and a stirring machine, and having a volume of 2.5 L, and was increased in temperature up to 87° C. under stirring. Next, under stirring, 169.5 g of 80% AA, 339.1 g of a 60 wt % aqueous solution of IPN50 (60 wt % aqueous solution of a 50 mol ethylene oxide adduct of isoprenol), 40.0 g of 15% NaPS (corresponding to 3.0 g with respect to 1 mol of the monomers in monomer components), and 39.9 g of 15% SHP were dropped into a polymerization reaction system at 87° C. When a time point at which the addition of the 80% AA was started was used a reference (0 minutes), the 80% AA, the 60% IPN50, and the 15% NaPS serving as an initiator were dropped at constant rates from 0 minutes to 120 minutes, from 0 minutes to 110 minutes, and from 0 minutes to 130 minutes, respectively. The 15% SHP serving as a chain transfer agent was dropped at an addition rate of 0.74 g/min from 0 minutes to 18 minutes and at an addition rate of 0.29 g/min from 18 minutes to 110 minutes. The components were dropped from nozzles different from each other, and a reaction liquid was kept at 87° C. under stirring.

After the completion of the dropping of the 15% NaPS, the reaction liquid was further kept at 87° C. for 30 minutes (aging), and polymerization was completed. After that, 12.6 g of 48% NaOH was added thereto. Thus, an aqueous solution of a fiber treatment agent (8) serving as a polymer H was obtained. The aqueous solution of the polymer H had a solid content concentration of 41.8 wt %. In addition, the polymer H had a weight average molecular weight of 50,000.

Regenerated cellulose cloth was subjected to fiber treatment with the fiber treatment agent (8), and evaluated for the wash durability and the moisture absorbing property.

The results are shown in Table 1.

### Example 13

Polyester cloth was subjected to fiber treatment with the fiber treatment agent (8) obtained in Example 12, and evaluated for the wash durability and the moisture absorbing property.

The results are shown in Table 1.

### Comparative Example 1

Regenerated cellulose cloth was evaluated for the wash durability and the moisture absorbing property in the same manner as in Example 1 except that the fiber treatment agent (1) was not used.

The results are shown in Table 1.

### Comparative Example 2

Polyester cloth was evaluated for the wash durability and the moisture absorbing property in the same manner as in Example 2 except that the fiber treatment agent (1) was not used.

The results are shown in Table 1.

TABLE 1

| | | | | | Evaluation |
|---|---|---|---|---|---|
| | | | | Evaluation | of moisture |
| | | | | of wash | absorbing |
| | Fiber | | | durability | property |
| | treat- | | Fixed | Fixed | Moisture |
| | ment | | amount | amount | absorption rate |
| | agent | Test cloth | (%) | (%) | (%) |
| Example 1 | (1) | Regenerated | 10 | 4 | 14.9 |
| | | cellulose | | | |
| Example 2 | (1) | Polyester | 12 | 12 | 3.3 |
| Example 3 | (2) | Regenerated | 6 | 4 | 14.4 |
| | | cellulose | | | |
| Example 4 | (2) | Polyester | 11 | 10 | 2.8 |
| Example 5 | (3) | Regenerated | 6 | 5 | 13.8 |
| | | cellulose | | | |
| Example 6 | (3) | Polyester | 10 | 9 | 3.0 |
| Example 7 | (4) | Polyester | 11 | 8 | 2.5 |
| Example 8 | (5) | Polyester | 9 | 8 | 3.0 |
| Example 9 | (6) | Regenerated | 10 | 4 | 14.3 |
| | | cellulose | | | |
| Example 10 | (7) | Regenerated | 9 | 6 | 15.0 |
| | | cellulose | | | |
| Example 11 | (7) | Polyester | 10 | 8 | 3.0 |
| Example 12 | (8) | Regenerated | 10 | 4 | 14.4 |
| | | cellulose | | | |
| Example 13 | (8) | Polyester | 10 | 7 | 2.9 |
| Comparative | None | Regenerated | 0 | 0 | 12.5 |
| Example 1 | | cellulose | | | |
| Comparative | None | Polyester | 0 | 0 | 0.4 |
| Example 2 | | | | | |

As shown in Table 1, in both cases in which regenerated cellulose is used as the test cloth and polyester is used as the test cloth, when the fiber treatment with the fiber treatment agent of the present invention is performed, the moisture absorption rate is increased (Examples 1, 3, 5, 9, 10, and 12 as compared to Comparative Example 1, and Examples 2, 4, 6, 7, 8, 11, and 13 as compared to Comparative Example 2). In addition, it is found that, when the fiber treatment with the fiber treatment agent of the present invention is performed, in both cases in which regenerated cellulose is used as the test cloth and polyester is used as the test cloth, a significant reduction in fixed amount in the evaluation of wash durability, which has been seen in fiber treatment with a related-art fiber treatment agent, is suppressed.

### Example 14

10.0 Grams of the aqueous solution of the polymer A obtained in Example 1 and 1.1 g of EPOCROS WS-700 (manufactured by Nippon Shokubai Co., Ltd., an oxazoline group-containing polymer, hereinafter abbreviated as “WS-700”) were sufficiently mixed. Thus, an aqueous solution of a fiber treatment agent (9) was obtained.

Regenerated cellulose cloth was subjected to fiber treatment with the fiber treatment agent (9), and evaluated for the wash durability and the moisture absorbing property.

The results are shown in Table 2.

### Example 15

Polyester cloth was subjected to fiber treatment with the fiber treatment agent (9) obtained in Example 14, and evaluated for the wash durability and the moisture absorbing property.

The results are shown in Table 2.

### Example 16

220.8 Grams of deionized water was loaded into a reaction vessel made of SUS including a reflux condenser and a stirring machine, and having a volume of 2.5 L, and was increased in temperature under stirring so that a boiling point reflux state was achieved. Next, under stirring, 151.0 g of 80% AA, 152.4 g of 40% HAPS, 147.3 g of IPN10 (a 10 mol ethylene oxide adduct of isoprenol), 97.0 g of 15% NaPS, and 31.3 g of 1% SHP were dropped into a polymerization reaction system in the boiling point reflux state. When a time point at which the addition of the 80% AA was started was used a reference (0 minutes), the 80% AA and the 40% HAPS were dropped at constant rates from 0 minutes to 180 minutes and from 0 minutes to 40 minutes, respectively. The IPN10 was dropped at a constant rate from 0 minutes to 170 minutes. The 15% NaPS serving as an initiator was dropped at an addition rate of 0.32 g/min from 0 minutes to 130 minutes and at an addition rate of 0.79 g/min from 130 minutes to 200 minutes. The 1% SHP serving as a reducing agent was dropped at a constant rate from 0 minutes to 170 minutes. The components were dropped from nozzles different from each other, and a reaction liquid was kept in the boiling point reflux state under stirring.

After the completion of the dropping of the 15% NaPS, the reaction liquid was further kept in the boiling point reflux state for 30 minutes (aging), and polymerization was completed. Thus, an aqueous solution of a polymer I was obtained. The aqueous solution of the polymer I had a solid content concentration of 44.1 wt %, and the polymer I had a weight average molecular weight of 38,100.

10.0 Grams of the aqueous solution of the polymer I and 0.7 g of EPOCROS WS-300 (manufactured by Nippon Shokubai Co., Ltd., an oxazoline group-containing polymer, hereinafter abbreviated as “WS-300”) were sufficiently mixed. Thus, an aqueous solution of a fiber treatment agent (10) was obtained.

Regenerated cellulose cloth was subjected to fiber treatment with the fiber treatment agent (10), and evaluated for the wash durability and the moisture absorbing property.

The results are shown in Table 2.

### Example 17

Polyester cloth was subjected to fiber treatment with the fiber treatment agent (10) obtained in Example 16, and evaluated for the wash durability and the moisture absorbing property.

The results are shown in Table 2.

### Comparative Example 3

Regenerated cellulose cloth was evaluated for the wash durability and the moisture absorbing property in the same manner as in Example 14 except that the fiber treatment agent (9) was not used.

The results are shown in Table 2.

### Comparative Example 4

Polyester cloth was evaluated for the wash durability and the moisture absorbing property in the same manner as in Example 15 except that the fiber treatment agent (9) was not used.

The results are shown in Table 2.

TABLE 2

| | | | | | Evaluation |
|---|---|---|---|---|---|
| | | | | Evaluation | of moisture |
| | | | | of wash | absorbing |
| | Fiber | | | durability | property |
| | treat- | | Fixed | Fixed | Moisture |
| | ment | | amount | amount | absorption rate |
| | agent | Test cloth | (%) | (%) | (%) |
| Example 14 | (9) | Regenerated | 10 | 7 | 15.5 |
| | | cellulose | | | |
| Example 15 | (9) | Polyester | 11 | 8 | 4.1 |
| Example 16 | (10) | Regenerated | 10 | 7 | 14.2 |
| | | cellulose | | | |
| Example 17 | (10) | Polyester | 11 | 7 | 2.4 |
| Comparative | None | Regenerated | 0 | 0 | 12.5 |
| Example 3 | | cellulose | | | |
| Comparative | None | Polyester | 0 | 0 | 0.4 |
| Example 4 | | | | | |

### Reference Examples 1 to 7

<Evaluation of Texture of Polyester Cloth after Fiber Treatment>

The polyester cloth obtained in each of Examples 2, 4, 6 to 8, 11, and 13 before washing was evaluated for a touch feeling.

A soft feeling was evaluated as “©”, a slightly soft feeling was evaluated as “0”, a slightly hard feeling was evaluated as “A”, and a hard feeling was evaluated as “x”.

The results are shown in Table 3.

TABLE 3

| | Fiber | | Fixed | |
|---|---|---|---|---|
| | treatment | | amount | Evaluation |
| | agent | Test cloth | (%) | of texture |
| Reference | (1) | Polyester | 10 | X |
| Example 1 | | | | |
| Reference | (2) | Polyester | 11 | X |
| Example 2 | | | | |
| Reference | (3) | Polyester | 10 | Δ |
| Example 3 | | | | |
| Reference | (4) | Polyester | 11 | ◯ |
| Example 4 | | | | |
| Reference | (5) | Polyester | 9 | X |
| Example 5 | | | | |
| Reference | (7) | Polyester | 10 | ⊚ |
| Example 6 | | | | |
| Reference | (8) | Polyester | 10 | ⊚ |
| Example 7 | | | | |

From the results of Reference Examples 1 to 7, it was found that, when fiber treatment with a copolymer obtained through copolymerization of an unsaturated polyalkylene glycol ether-based monomer was performed, the evaluation of texture was satisfactory.

### Reference Examples 8 to 11

<Evaluation of Texture of Regenerated Cellulose Cloth after Fiber Treatment>

The regenerated cellulose cloth obtained in each of Examples 1, 9, 10, and 12 before washing was evaluated for a touch feeling.

A soft feeling was evaluated as “⊚”, a slightly soft feeling was evaluated as “∘”, a slightly hard feeling was evaluated as “Δ”, and a hard feeling was evaluated as “×”.

The results are shown in Table 4.

TABLE 4

| | Fiber | | Fixed | |
|---|---|---|---|---|
| | treatment | | amount | Evaluation |
| | agent | Test cloth | (%) | of texture |
| Reference | (1) | Regenerated | 10 | X |
| Example 8 | | cellulose | | |
| Reference | (6) | Regenerated | 10 | ◯ |
| Example 9 | | cellulose | | |
| Reference | (7) | Regenerated | 9 | ⊚ |
| Example 10 | | cellulose | | |
| Reference | (8) | Regenerated | 10 | ⊚ |
| Example 11 | | cellulose | | |

From the results of Reference Examples 8 to 11, it was found that, when fiber treatment with a copolymer obtained through copolymerization of an unsaturated polyalkylene glycol ether-based monomer was performed, the evaluation of texture was satisfactory.

### INDUSTRIAL APPLICABILITY

The fiber treatment agent of the present invention can be utilized, for example, for fiber treatment of cellulose fibers or polyester fibers.

What is claimed is:

1-14. (canceled)

15. A fiber treatment agent, comprising a copolymer (A) having a structural unit (I) derived from a carboxyl group-containing monomer (a) and a structural unit (II) derived from a hydroxy group-containing monomer (b),
the carboxyl group-containing monomer (a) being represented by the general formula (a-1), the structural unit (I) being represented by the general formula (I-1): 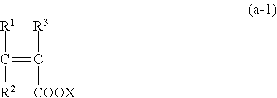
in the general formula (a-1), R¹ to R³ are identical to or different from each other, and each represent a hydrogen atom, a methyl group, or a —(CH₂)_{z}COOM group, the —(CH₂)_{z}COOM group may form an anhydride with a —COOX group or any other —(CH₂)_{z}COOM group, z represents an integer of from 0 to 2, M represents a hydrogen atom, an alkali metal, an alkaline earth metal, an ammonium group, an organic ammonium group, or an organic amine group, and X represents a hydrogen atom, an alkali metal, an alkaline earth metal, an ammonium group, an organic ammonium group, or an organic amine group; 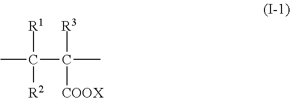
in the general formula (I-1), R¹ to R³ are identical to or different from each other, and each represent a hydrogen atom, a methyl group, or a —(CH₂)_{z}COOM group, the —(CH₂)_{z}COOM group may form an anhydride with a —COOX group or any other —(CH₂)_{z}COOM group, z represents an integer of from 0 to 2, M represents a hydrogen atom, an alkali metal, an alkaline earth metal, an ammonium group, an organic ammonium group, or an organic amine group, and X represents a hydrogen atom, an alkali metal, an alkaline earth metal, an ammonium group, an organic ammonium group, or an organic amine group,
the hydroxy group-containing monomer (b) comprising an unsaturated polyalkylene glycol ether-based monomer represented by the general formula (2): 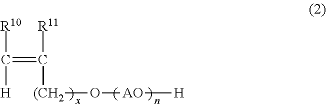
in the general formula (2), R¹⁰ and R¹¹ are identical to or different from each other, and each represent a hydrogen atom or a methyl group, AO represents an oxyalkylene group having 2 to 18 carbon atoms, n represents an average number of moles added of oxyalkylene groups each represented by AO, n represents a number of from 1 to 500, and x represents an integer of from 0 to 2.

16. The fiber treatment agent according to claim 15, wherein the hydroxy group-containing monomer (b) comprises a compound obtained by adding, on average, 1 mol to 500 mol of an alkylene oxide to 3-methyl-3-buten-1-ol.

17. The fiber treatment agent according to claim 16, wherein an average number of moles added of the alkylene oxide is from 8 to 500.

18. The fiber treatment agent according to claim 15, wherein the hydroxy group-containing monomer (b) comprises a sulfonic acid group-containing ether compound represented by the general formula (1): 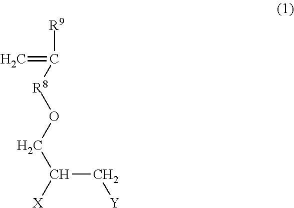
in the general formula (1), R⁸ represents any one of a single bond, CH₂, and CH₂CH₂, R⁹ represents any one of H and CH₃, and one of X and Y represents a hydroxy group, and another thereof represents a sulfonic acid (salt) group.

19. The fiber treatment agent according to claim 15, further comprising a cross-linking agent (B) having an oxazoline group.

20. A fiber treatment method including treating fibers with a fiber treatment agent,
the fiber treatment method comprising treating fibers with a fiber treatment agent to impart moisture absorbing and releasing properties and/or wash durability to the fibers,
the fiber treatment agent comprising a fiber treatment agent comprising a copolymer (A) having a structural unit (I) derived from a carboxyl group-containing monomer (a) and a structural unit (II) derived from a hydroxy group-containing monomer (b),
the carboxyl group-containing monomer (a) being represented by the general formula (a-1), the structural unit (I) being represented by the general formula (I-1): 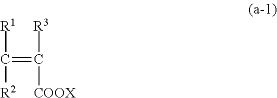
in the general formula (a-1), R¹ to R³ are identical to or different from each other, and each represent a hydrogen atom, a methyl group, or a —(CH₂)_{z}COOM group, the —(CH₂)_{z}COOM group may form an anhydride with a —COOX group or any other —(CH₂)_{z}COOM group, z represents an integer of from 0 to 2, M represents a hydrogen atom, an alkali metal, an alkaline earth metal, an ammonium group, an organic ammonium group, or an organic amine group, and X represents a hydrogen atom, an alkali metal, an alkaline earth metal, an ammonium group, an organic ammonium group, or an organic amine group; 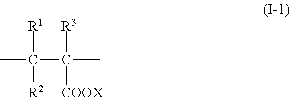
in the general formula (I-1), R¹ to R³ are identical to or different from each other, and each represent a hydrogen atom, a methyl group, or a —(CH₂)_{z}COOM group, the —(CH₂)_{z}COOM group may form an anhydride with a —COOX group or any other —(CH₂)_{z}COOM group, z represents an integer of from 0 to 2, M represents a hydrogen atom, an alkali metal, an alkaline earth metal, an ammonium group, an organic ammonium group, or an organic amine group, and X represents a hydrogen atom, an alkali metal, an alkaline earth metal, an ammonium group, an organic ammonium group, or an organic amine group,
the hydroxy group-containing monomer (b) comprising an unsaturated polyalkylene glycol ether-based monomer represented by the general formula (2): 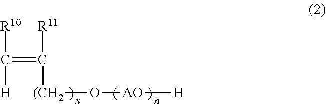
in the general formula (2), R¹⁰ and R¹¹ are identical to or different from each other, and each represent a hydrogen atom or a methyl group, AO represents an oxyalkylene group having 2 to 18 carbon atoms, n represents an average number of moles added of oxyalkylene groups each represented by AO, n represents a number of from 1 to 500, and x represents an integer of from 0 to 2.

21. The fiber treatment method according to claim 20, wherein the carboxyl group-containing monomer (a) comprises a monoethylenically unsaturated monocarboxylic acid (salt) serving as a monomer (a1).

22. The fiber treatment method according to claim 21, wherein the carboxyl group-containing monomer (a) comprises (meth)acrylic acid (salt).

23. The fiber treatment method according to claim 20, wherein the hydroxy group-containing monomer (b) comprises a compound obtained by adding, on average, 1 mol to 500 mol of an alkylene oxide to 3-methyl-3-buten-1-ol.

24. The fiber treatment method according to claim 23, wherein an average number of moles added of the alkylene oxide is from 8 to 500.

25. The fiber treatment method according to claim 20, wherein the hydroxy group-containing monomer (b) comprises a sulfonic acid group-containing ether compound represented by the general formula (1): 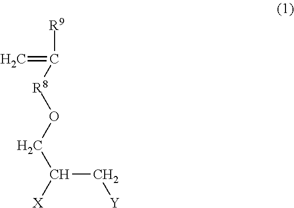
in the general formula (1), R⁸ represents any one of a single bond, CH₂, and CH₂CH₂, R⁹ represents any one of H and CH₃, and one of X and Y represents a hydroxy group, and another thereof represents a sulfonic acid (salt) group.

26. The fiber treatment method according to claim 20, wherein the fiber treatment agent further comprises a cross-linking agent (B) having an oxazoline group.

27. The fiber treatment method according to claim 20, wherein the fiber treatment agent is to be fixed to fiber cloth by dipping the fiber cloth into an aqueous solution of the fiber treatment agent, followed by dewatering, and heating to dryness.

28. The fiber treatment method according to claim 27, wherein the fiber cloth comprises dried fiber cloth.

29. The fiber treatment method according to claim 20, wherein the fiber treatment method comprises treating polyester fibers.

30. A polyester fiber, which is treated by the fiber treatment method of claim 20.

31. The fiber treatment method according to claim 20, wherein the fiber treatment method comprises the steps of:
dipping fiber cloth into an aqueous solution of the fiber treatment agent;
dewatering; and
fixing the fiber treatment agent to the fiber cloth through heating to dryness.

32. The fiber treatment method according to claim 31, wherein the fiber treatment method further comprises, before the dipping step, drying the fiber cloth.

33. The fiber treatment method according to claim 31, wherein the fixing step comprises heating the fiber cloth to dryness at a temperature of from 100° C. to 160° C.
